(19) United States
(12) Patent Application Publication
(10) Pub. No.: US 2018/0364633 A1
(43) Pub. Date: Dec. 20, 2018

(54) IMAGE FORMING APPARATUS

(71) Applicant: KYOCERA Document Solutions Inc., Osaka (JP)

(72) Inventors: Shingo SAKATO, Osaka-shi (JP); Katsuya OTA, Osaka-shi (JP)

(73) Assignee: KYOCERA Document Solutions Inc., Osaka (JP)

(21) Appl. No.: 15/991,153

(22) Filed: May 29, 2018

(30) Foreign Application Priority Data
Jun. 15, 2017 (JP) 2017-118076

(51) Int. Cl. G03G 21/00; G03G 15/16; G03G 15/04; G03G 15/08

(52) U.S. Cl. CPC G03G 21/0011; G03G 15/161; G03G 15/0832; G03G 15/0887; G03G 15/04072

(57) ABSTRACT

An image forming apparatus includes an image carrier carrying a toner image, a developing device carrying out developing process feeding toner to the image carrier during image forming, and a cleaning blade coming into contact with the image carrier and removing waste toner on the image carrier. Turning-up restraining process feeds the toner of a constant feeding amount from the developing device to the image carrier. Replacing process feeds the toner of a variation feeding amount according to an average printing rate from the developing device to the image carrier. During non-image forming, every time a given cumulative printing number of image forming operation is finished, the replacing process is carried out in a case where the variation feeding amount according to the average printing rate in the cumulative printing number of developing process exceeds the constant feeding amount, but the turning-up restraining process is carried out otherwise.

### INCORPORATION BY REFERENCE

This application is based on and claims the benefit of priority from Japanese Patent application No. 2017-118076 filed on Jun. 15, 2017, the entire contents of which are incorporated herein by reference.

### BACKGROUND

The present disclosure relates to an image forming apparatus including a cleaning blade removing waste toner remained on an image carrier carrying a toner image.

Conventionally, an image forming apparatus of an electrographic manner, such as a printer or a copying machine, includes an image carrier, such as a photosensitive drum, having a surface carrying a toner image. In addition, the image forming apparatus includes a developing device developing the toner image onto the image carrier and a transferring device transferring the toner image on the image carrier onto a recording medium, such as a sheet. Further, the image forming apparatus includes a cleaning device removing waste toner remained on the image carrier by a cleaning blade after transferring.

The cleaning blade is arranged so that its blade edge comes into contact with the surface of the image carrier in a counter direction to a rotating direction of the image carrier. When the image carrier is rotated, by lubricity of an eternal additive of the waste toner on the image carrier, a stick-slip phenomenon of the cleaning blade to the image carrier is restrained. Therefore, if the eternal additive is exhausted, frictional force between the cleaning blade and the surface of the image carrier is increased, balance of the stick-slip phenomenon is lost, and blade turning-up may be caused so that the cleaning blade is turned up in an opposite direction to the counter direction. It is feared that image failure is caused due to the blade turning-up. In order to restrain the blade turning-up, in the image forming apparatus, toner placing (turning-up restraining process) may be carried out so as to feed toner from the developing device to the image carrier. In the turning-up restraining process, the toner is placed (fed) from the developing device onto the image carrier.

As an example, the image forming apparatus includes an image carrier, a driving means driving the image carrier for image forming, a latent image forming means forming a latent image onto the image sensor, a developing means developing the latent image on the image sensor to form a developing image, a transferring means transferring the developing image on the image sensor to a transferred material, a cleaning means having a cleaning blade cleaning residual substances remained on a surface of the image carrier after transferring the developing image on the image carrier, and a toner pattern forming means forming a toner pattern on the image carrier after image forming before stopping the driving means.

As another example, the image forming apparatus rotate photosensitive bodies while switching a rotating rate of each photosensitive body between a plurality of rotating rates. The image forming apparatus has a color image forming mode forming a color image by using respective imaging units and a monochrome image forming mode forming a monochrome image by using only one imaging unit. In the monochrome image forming mode, in imaging units not used for imaging, photosensitive bodies are rotated and rotations of developing devices are stopped. However, in the monochrome image forming mode, when the rotating speed of the photosensitive bodies is switched, the developing devices in imaging units not used for imaging are rotated for a predetermined time.

Further, the developing device stores toner for developing the toner image, but in a case where developing of a relatively low printing rate is frequently carried out, the toner may not be used and may be kept being stored, and then, may be degraded. If the degraded toner may be used, failure of the developed toner image may occur. The image forming apparatus may, in order to restrain use of the degraded toner, carry out toner ejection (replacing process) forcedly replacing the stored toner. In the replacing process, in order to supply new toner to the developing device, old toner is ejected (fed) from the developing device to the image carrier. In the replacing process, if a sufficient amount of the toner is added to the image carrier, frictional force between the cleaning blade and the surface of the image carrier is restrained and a load of the cleaning blade is reduced.

In the above-mentioned replacing process, a toner feeding amount (a variation feeding amount) from the developing device to the image carrier may be changed according to a printing rate. For example, the variation feeding amount is set to larger value, as the printing rate becomes lower. The variation feeding amount is set to a maximum when the printing rate is 0%, and the variation feeding amount is set to zero when the printing rate is a predetermined relatively low threshold value. In the above-mentioned turning-up restraining process, the toner feeding amount (a constant feeding amount) from the developing device to the image carrier is set to, for example, a constant value of a lower limit smaller than a maximum of the variation feeding amount in the replacing process. The turning-up restraining process and the replacing process have a common point feeding the toner from the developing device to the image carrier, and therefore, are does not need to be carried out simultaneously.

Thereupon, the image forming apparatus may carry out the turning-up restraining process in a case where the printing rate is equal to and more than a predetermined threshold value, but carry out the replacing process in a case where the printing rate is less than the predetermined threshold value. However, as the printing rate approaches to a predetermined threshold, the variation feeding value of the replacing process approaches to zero, and accordingly, the toner ejected from the developing device is decreased and the toner placed on the image carrier is decreased. Therefore, it is feared that frictional force between the cleaning blade and the surface of the image carrier is increased and a load of the cleaning blade is increased. Thus, it is feared that image failure is caused due to the blade turning-up.

### SUMMARY

In accordance with an embodiment of the present disclosure, an image forming apparatus includes an image carrier carrying a toner image, a developing device and a cleaning blade. The developing device carries out developing process feeding toner to the image carrier during image forming. The cleaning blade comes into contact with the image carrier and removes waste toner remained on the image carrier. The image forming apparatus is configured to carry out, in order to restrain turning-up of the cleaning blade, turning-up restraining process feeding the toner of a constant feeding amount from the developing device to the image carrier, and to carry out, in order to replace the toner stored in the developing device, replacing process feeding the toner of a variation feeding amount according to an average printing rate from the developing device to the image carrier. During non-image forming, every time a given cumulative printing number of image forming operation is finished, the replacing process is carried out in a case where the variation feeding amount according to the average printing rate in the cumulative printing number of developing process exceeds the constant feeding amount, but the turning-up restraining process is carried out otherwise.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a sectional view schematically showing a printer according to an embodiment of the present disclosure.

FIG. 2 is a graph plotting an average printing rate of a cumulative printing number of image forming operation and a toner feeding amount with respect to turning-up restraining process of a cleaning blade and replacing process of toner in a developing device in the printer according to the embodiment of the present disclosure.

FIG. 3 is a partial enlarged graph of the graph in FIG. 2.

### DETAILED DESCRIPTION

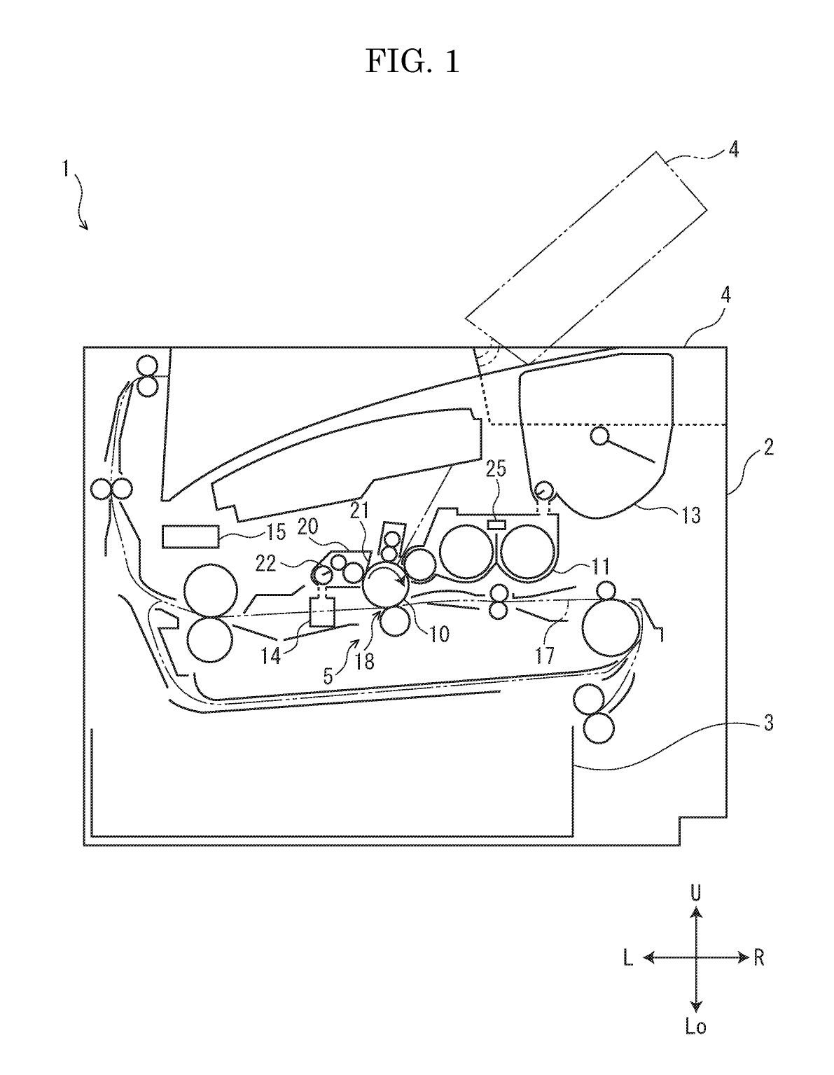

First, the entire structure of a printer 1 (an image forming apparatus) according to an embodiment of the present disclosure will be described with reference to FIG. 1. For convenience sake, it will be described so that the front side of the printer 1 is positioned at a near side on a paper sheet of FIG. 1. Arrows L, R, U and Lo in each of the drawings respectively indicate a left side, a right side, an upper side and a lower side of the printer 1.

The printer 1 includes a box-like formed printer body 2. In a lower part of the printer body 2, a sheet feeding cartridge 3 storing sheets is installed. In an upper face of the printer body 2, an ejected sheet tray is formed. In the upper face of the printer body 2, in order to attach and detach a toner container 13 described below with respect to the printer body 2, an upper cover 4 is openably/closably attached at a side of the ejected sheet tray.

Inside the printer body 2, an exposing device composed of a laser scanning unit (LSU) is located below the ejected sheet tray. Below the exposing device, an image forming part 5 is arranged. In the image forming part 5, the photosensitive drum 10 as an image carrier is rotatably arranged. The photosensitive drum 10 is composed of, for example, amorphous silicon photosensitive body (photoreceptor). Around the photosensitive drum 10, a charging device, a developing device 11, a transferring roller and a cleaning device 12 are located along a rotating direction of the photosensitive drum 10.

To the developing device 11, the toner container 13 containing toner replenished to the developing device 11 is attachably/detachably (replaceably) connected. To the cleaning device 12, a waste toner box 14 collecting waste toner removed from the photosensitive drum 10 by the cleaning device 12 is attachably/detachably (replaceably) connected.

Moreover, inside the printer body 2, a controlling device 15 controlling operations, such as image forming of the printer 1, turning-up restraining process of a cleaning blade 21 of the cleaning device 12 and replacing process of the toner stored in the developing device 11, is provided. The controlling device 15 is composed of, for example, a controlling part, such as CPU, and a storing part, such as ROM and RAM.

Further, inside the printer body 2, a conveying path 17 for the sheet is arranged. At an upstream end of the conveying path 17, a sheet feeding part is positioned near the sheet feeding cartridge 3. At an intermediate stream part of the conveying path 17, a transferring part composed of the photosensitive drum 10 and the transferring roller is positioned. At a downstream part of the conveying path 17, a fixing device is positioned. At a downstream end of the conveying path 17, a sheet ejecting part is positioned near the ejected sheet tray.

Next, image forming operation of the printer 1 including such configuration will be described. In the printer 1, when image data is inputted and a printing start is directed from an external computer or the like connected with the printer 1, image forming operation is started. First, in the image forming part 5, the surface of the photosensitive drum 10 is electrically charged by the charging device, and then, is exposed on the basis of the image data by a laser light from the exposing device, thereby forming an electrostatic latent image on the surface of the photosensitive drum 10. Subsequently, the electrostatic latent image is developed to a toner image by the developing device 11 using toner in the image forming part 5.

On the other hand, the sheet stored in the sheet feeding cartridge 3 is picked up by the sheet feeding part and conveyed on the conveying path 17. The sheet on the conveying path 17 is conveyed to the transferring part 18 in a given timing and, in the transferring part 18, the toner image on the photosensitive drum 10 is transferred onto the sheet. The sheet with the transferred toner image is conveyed to the fixing device and, in the fixing device, the toner image is fixed on the sheet. The sheet with the fixed toner image is ejected from the sheet ejecting part to the sheet ejected tray. Incidentally, the toner (waste toner) remained on the photosensitive drum 10 is removed by the cleaning device 12.

Next, the developing device 11 will be described, the developing device 11 is controlled by the controlling device 15 to carry out developing process feeding the toner to the photosensitive drum 10 during image forming, during turning-up restraining process of the cleaning blade 21 of the cleaning device 12 and during replacing process of the stored toner.

The developing device 11 includes, for example, a developing roller feeding the toner to the photosensitive drum 10, and an agitating member and a conveying member agitating and conveying the toner, in a housing. The housing has a replenishing port receiving toner replenishing from the toner container 13 and is connected to the toner container 13 via the replenishing port. In addition, the developing device 11 includes a toner amount detecting part 25 detecting a toner amount in the housing and the toner amount detecting part 25 is composed of, for example, a toner density sensor detecting toner density. The developing device 11 receives toner replenishing from the toner container 13 when the toner amount becomes less than a predetermined value.

Next, the cleaning device 12 will be described. The cleaning device 12 removes, from the photosensitive drum 10, the waste toner remained on the photosensitive drum 10 after transferring. The cleaning device 12 includes, for example, a case 20, the cleaning blade 21 and a collecting member 22.

The case 20 is formed in a box-like shape elongated in the rotation axis direction of the photosensitive drum 10 to temporarily store the waste toner removed from the photosensitive drum 10. The case 20 has an opening at a right side and the cleaning device 12 is arranged so that the opening of the case 20 faces to a left side of the surface of the photosensitive drum 10. In addition, the case 20 has an ejecting port ejecting the waste toner to the waste toner box 14 and is connected to the waste toner box 14 via the ejecting port. Incidentally, the case 20 may be connected to the waste toner box 14 via a conveying device conveying the waste toner to the waste toner box 14.

The cleaning blade 21 is made of elastic material, such as urethane rubber, and is formed in a plate-like shape elongated in the rotation axis direction of the photosensitive drum 10. The cleaning blade 21 is attached to the case 20 so that its distal end is positioned at a side of the opening of the case 20 to come into contact with the surface of the photosensitive drum 10 in a counter direction to the rotating direction of the photosensitive drum 10.

The collecting member 22 is formed, for example, as a spiral member elongated in the rotation axis direction of the photosensitive drum 10 and is rotatably arranged in the vicinity of the ejecting port inside the case 20. The collecting member 22 is connected to a driving part (not shown), such as a motor. When the controlling device 15 activates the driving part, the collecting member 22 is rotated by receiving driving force from the driving part. When the collecting member 22 is rotated, the waste toner in the case 20 is conveyed to the waste toner box 14 via the ejecting port.

Next, turning-up restraining process of the cleaning blade 21 of the cleaning device 12 and replacing process of the developing device 11 will be described. The turning-up restraining process and the replacing process are controlled, as described above, by the controlling device 15 so that any one of the turning-up restraining process and the replacing process is carried out when a predetermined process condition is satisfied. The turning-up restraining process and the replacing process have a common point feeding the toner from the developing device 11 to the photosensitive drum 10 and replenishing new toner from the toner container 13 to the developing device 11 during non-image forming. As the process condition, for example, passing of the predetermined number or a predetermined time of image forming operation (printing operation of the sheet) is set.

Concretely, as the process condition, the cumulative number of printed sheets, i.e., the cumulative printing number (e.g. 100) is set. Then, the controlling device 15 counts the number of image forming operation, i.e., the number of printed sheets or the printing number, from start to end (replacement) of use of the toner container 13 and decides whether or not the printing number reaches the cumulative printing number. If the printing number reaches the cumulative printing number, the controlling device 15 controls components of the printer 1 so as to carry out any one of the turning-up restraining process and the replacing process at a timing of non-image forming and to reset the printing number to zero. In other words, assuming that the cumulative printing number of image forming operation is one section, the controlling device 15 carries out the turning-up restraining process or the replacing process every time each section is finished. Incidentally, the controlling device 15 may count the total number of printed sheets, i.e., the total printing number, from start to end of use of the toner container 13.

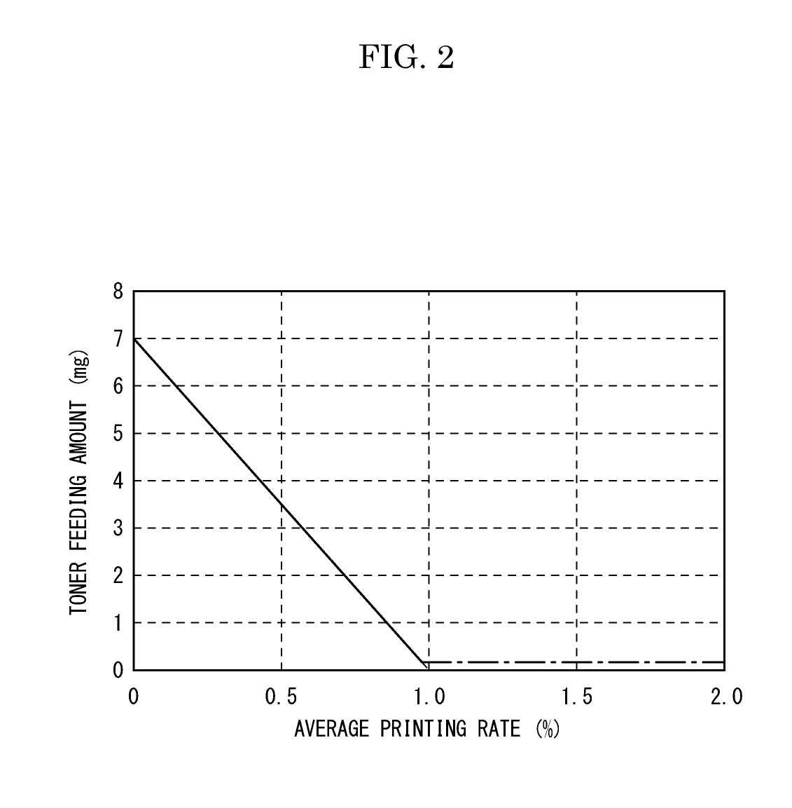

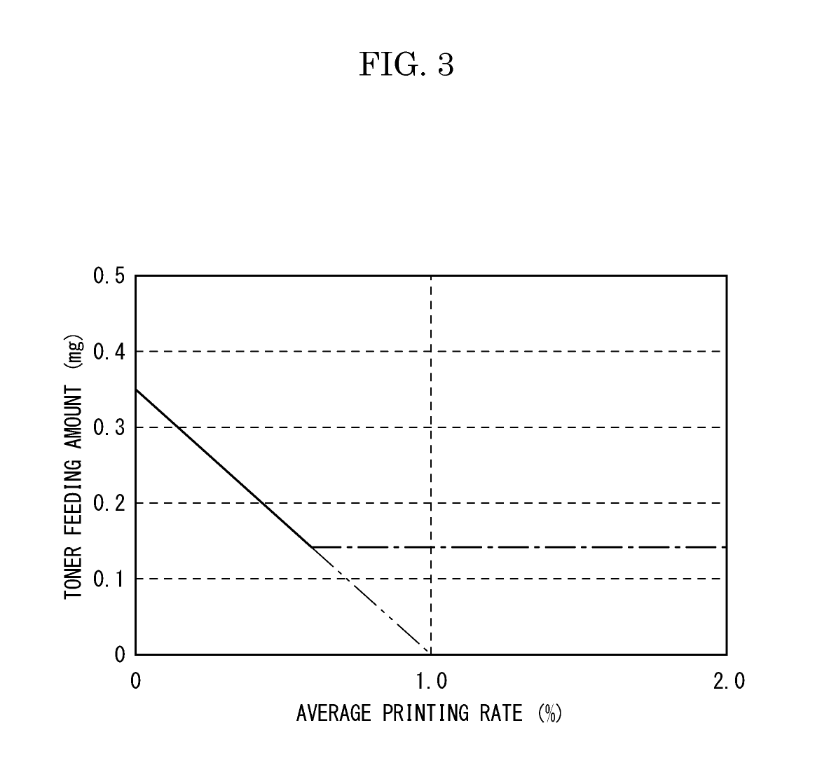

In the turning-up restraining process, as shown in FIGS. 2 and 3, a toner feeding amount from the developing device 11 to the photosensitive drum 10 (a constant feeding amount, refer to a dot chain line in FIGS. 2 and 3) is set to, for example, 0.13 to 0.15 mg per sheet of a predetermined size (e.g. A4 size). Subsequently, the toner corresponding to the cumulative printing number of the toner feeding amount is fed to from the developing device 11 to the photosensitive drum 10.

In the replacing process, as shown in FIGS. 2 and 3, a toner feeding amount from the developing device 11 to the photosensitive drum 10 (a variation feeding amount, refer to a solid line in FIGS. 2 and 3) is calculated on the basis of an average printing rate RIA of the cumulative printing number of image forming operation in the corresponding section. Incidentally, the printing rate is converted into a predetermined size (e.g. A4 size) regardless a size of a printed sheet. For example, when the printing rate of printing operation with respect to A5 size is 2%, the printing rate is converted into 1% for A4 size.

The variation feeding amount in the replacing process is set to larger value, as the average printing rate RIA becomes lower. For example, the variation feeding amount is set to maximum (e.g. 7 mg per sheet of a predetermined size (e.g. A4 size)) when the average printing rate RIA is 0%. Moreover, the variation feeding amount is set to smaller value, as the average printing rate RIA becomes higher and calculated, for example, by a mathematical expression of 7-700*RIA [mg]. According to the mathematical expression, in a case where the average printing rate RIA is 0.005 (0.5%), the variation feeding amount is 3.5 [mg]. Then, the toner corresponding to the cumulative printing number of the variation feeding amount is fed from the developing device 11 to the photosensitive drum 10. Alternatively, the variation feeding amount may be calculated by an amount corresponding to a difference between an upper limit printing rate and the average printing rate RIA when the upper limit printing rate (e.g. 1%) is preset as an upper limit for carrying out the replacing process.

Next, decision process of the turning-up restraining process and the replacing process will be described. The decision process is controlled by the controlling device 15. The controlling device 15 calculates, when the cumulative printing number of image forming operation is finished, the variation feeding amount of the replacing process on the basis of the average printing rate RIA corresponding to this cumulative printing number of image forming operation. Subsequently, the controlling device 15 controls to carry out the replacing process if the variation feeding amount exceeds the constant feeding amount, but to carry out the turning-up restraining process if the variation feeding amount is equal to or less than the constant feeding amount.

In accordance with the embodiment, as described above, the printer 1 (the image forming apparatus) includes the photosensitive drum 10 (image carrier) carrying the toner image, the developing device 11 carrying out developing process feeding the toner to the photosensitive drum 10 during image forming, and the cleaning blade 21 coming into contact with the photosensitive drum 10 and removing the waste toner remained on the photosensitive drum 10. The printer 1 is configured to carry out, in order to restrain turning-up of the cleaning blade 21, turning-up restraining process feeding the toner of the constant feeding amount from the developing device 11 to the photosensitive drum 10, and to carry out, in order to replace the toner stored in the developing device 11, replacing process feeding the toner of the variation feeding amount according to the average printing rate RIA from the developing device 11 to the photosensitive drum 10. Subsequently, the printer 1 carries out, during non-image forming, every time the given cumulative printing number of image forming operation is finished, the replacing process in a case where the variation feeding amount according to the average printing rate in the cumulative printing number of developing process exceeds the constant feeding amount, but carries out the turning-up restraining process otherwise.

According to such configuration, the turning-up restraining process and the replacing process are not carried out simultaneously. Subsequently, when the variation feeding amount of the toner calculated in the replacing process for the toner approaches to zero, the turning-up restraining process of the cleaning blade 21 is carried out by the constant feeding amount, in place of the replacing process. Therefore, in the replacing process for the toner, the toner ejected from the developing device 11 is not decreased, and then, new toner of an appropriate amount is supplied to the developing device 11. Thus, it is possible to restrain degradation of the toner stored in the developing device 11 and to restrain image failure. In addition, in the turning-up restraining process of the cleaning blade 21, it is possible to place a sufficient amount of the toner on the photosensitive drum 10, and then, to restrain increase of frictional force between the cleaning blade 21 and the surface of the photosensitive drum 10 and to reduce a load of the cleaning blade 21. Therefore, it is possible to restrain turning-up of the cleaning blade 21 and to restrain image failure.

For example, the variation feeding amount may be calculated as the amount corresponding to the difference between the upper limit printing rate preset as an upper limit for carrying out the replacing process and the average printing rate RIA.

According to such configuration, it is possible to more appropriately calculate the variation feeding amount of the toner required for the replacing process of the toner of the developing device 11.

Moreover, in the embodiment, the photosensitive drum 10 may be composed of an amorphous silicon photosensitive body (photoreceptor). In a case where the amorphous silicon photosensitive body is applied into the photosensitive drum 10, increasing of frictional force to the cleaning blade 21 is feared. However, in the embodiment, as described above, since the appropriate toner feeding amount for turning-up restraining process of the cleaning blade 21 is used, it is possible to restrain frictional force between the photosensitive drum 10 and the cleaning blade 21. Further, since the amorphous silicon photosensitive body is applied into the photosensitive drum 10, it is possible to improve durability of the photosensitive drum 10.

The embodiment was described in a case of applying the configuration of the present disclosure to the monochrome printer 1. On the other hand, in another embodiment, the configuration of the disclosure may be applied to another image forming apparatus, such as a color printer, a copying machine, a facsimile or a multifunction peripheral.

While the present disclosure has been described with reference to the particular illustrative embodiments, it is not to be restricted by the embodiments. It is to be appreciated that those skilled in the art can change or modify the embodiments without departing from the scope and spirit of the present disclosure.

1. An image forming apparatus comprising:
an image carrier carrying a toner image;
a developing device carrying out developing process feeding toner to the image carrier during image forming; and
a cleaning blade coming into contact with the image carrier and removing waste toner remained on the image carrier,
wherein the image forming apparatus is configured to carry out, in order to restrain turning-up of the cleaning blade, turning-up restraining process feeding the toner of a constant feeding amount from the developing device to the image carrier, and to carry out, in order to replace the toner stored in the developing device, replacing process feeding the toner of a variation feeding amount according to an average printing rate from the developing device to the image carrier,
during non-image forming, every time a given cumulative printing number of image forming operation is finished, the replacing process is carried out in a case where the variation feeding amount according to the average printing rate in the cumulative printing number of developing process exceeds the constant feeding amount, but the turning-up restraining process is carried out otherwise.

2. The image forming apparatus according to claim 1, wherein
the variation feeding amount is calculated as an amount corresponding to a difference between an upper limit printing rate preset as an upper limit for carrying out the replacing process and the average printing rate.

3. The image forming apparatus according to claim 1, wherein
the variation feeding amount is set to larger value, as the average printing rate becomes lower, but the variation feeding amount is set to maximum when the average printing rate is 0%.

4. The image forming apparatus according to claim 1, wherein
the image carrier is composed of an amorphous silicon photosensitive body.
